(19) United States
(12) Patent Application Publication
(10) Pub. No.: US 2006/0068357 A1
(43) Pub. Date: Mar. 30, 2006

(54) Metal dental impression tray

(76) Inventors: Vincent Anthony Paradiso, New Milford, CT (US); Peter George Jordan, London (CA)

Correspondence Address: Miller, Canfield, Paddock and Stone P.L.C.;c/o Robert Kelley Roth, Suite 2500, 150 West Jefferson Ave., Detroit, MI, 48226, US

(21) Appl. No.: 10/954,335

(22) Filed: Sep. 30, 2004

(51) Int. Cl. A61C 5/04

(52) U.S. Cl. 433/39

(57) ABSTRACT

A dental impression tray is disclosed comprising a frame having left and right side walls and a distal bar. The distal bar has a distal end and structural arcs on either side of the distal end which connect the distal bar to the corresponding left and right side walls, and a mesh is attached to the frame at the side walls and at the distal end. The mesh cooperates with the frame to define openings formed between the mesh and the structural arcs.

### FIELD OF THE INVENTION

This invention relates to improvements in dental impression trays, and more particularly to improvements in metal dental impression trays.

### BACKGROUND OF THE INVENTION

Dental impression trays are often used by dentists, orthodontists, and others engaged in various fields of dentistry to make an impression of selected areas of a patient's teeth and gums. For example, the dentist may desire to have an impression of an area of a patient's dentition (often including not just one tooth but also adjacent teeth and opposing teeth) where one or more teeth are missing or damaged, so that a suitable prosthesis may be made from a model taken from the impression as a guide. Commonly a dentist will take an impression of a tooth that has been damaged via an accident or deterioration through natural aging. The impression is an accurate replica of the tooth or teeth. Once completed, the impression is subsequently sent to a dental laboratory where it is “poured up” in dental stone, creating a positive model of the dentist's impression. This model is then used to fabricate a replacement prosthesis (such as a new crown bridge or denture) and is sent back to the dentist for insertion into the patient's mouth. The models may also serve as a permanent record of a patient's teeth before and after treatment, and sometimes at selected intervals during treatment.

To prepare an impression, curable elastomeric dental impression material is placed in an impression tray and the tray is positioned in the patient's mouth so that the impression material fills and surrounds the selected area to be restored. Once the impression material has cured, a finished impression along with the tray is removed from the mouth as one unit. A dental model of the patient's tooth structure and gingival tissue can be made from the finished impression.

A variety of dental impression trays are available to hold dental impression material as impressions are made. Some dental impression trays have an overall, generally “U”-shaped configuration in plan view that matches the overall, generally “U”-shaped configuration of the patient's upper or lower dental arch. These are referred to as full arch trays. Other impression trays have an overall, generally “J”-shaped configuration in plan view for making an impression of one quadrant of the patient's oral cavity (i.e., the right or left half of either the patient's upper dental arch or lower dental arch). These are known as quadrant or quad arch trays. Quadrant arch tray designs allow impressions to be made of both the upper and lower mouth simultaneously and are known as dual arch trays. Typically, a central area of the dental impression tray has a mesh or other generally flat material which serves as a support for holding dental impression material. The dental impression material can comprise one of several elastomeric dental impression materials including, for example, reversible hydrocolloids, irreversible hydrocolloids, polysulfides, polyethers, and condensation silicones, especially polyvinyl siloxanes.

Dental impression trays are commercially available in a variety of materials, including stainless steel or aluminum. Other, less rigid impression trays are made of a plastic material such as polyethylene or polypropylene, or made of polystyrene foam. Plastic dental impression trays have problems associated with their relative flexibility. More specifically, plastic trays may partially distort when a patient bites down with the tray/dental impression material in the mouth. When the patient opens his mouth and the plastic tray is removed, the plastic often rebounds, and this rebound can cause distortions in the impression, which in turn produces distortions in the model and ultimately the prosthesis. Even slight rebounding can produce prostheses that simply do not fit, or are at best uncomfortable or unacceptable to the patient. For this reason it is generally preferable to use metal trays. Although known metal trays work well, it would be desirable to have an improved metal, memory-free, sideless dental impression tray to avoid rebounding. Rebounding is caused by horizontal stress from a mesh pulling on the side walls of the tray and axial roll caused by the viscous impression material flexing or bending an arm of the tray.

### SUMMARY OF THE INVENTION

In accordance with a first aspect, a dental impression tray is disclosed comprising a frame having left and right side walls and a distal bar. The distal bar has a distal end and structural arcs on either side of the distal end which connect the distal bar to the corresponding left and right side walls, and a mesh is attached to the frame at the side walls and at the distal end, and the mesh cooperates with the frame to define openings formed between the mesh and the structural arcs. In accordance with another aspect the distal end is tapered to help reduce impingement of teeth and gums at the retro molar pad.

From the foregoing disclosure and the following more detailed description of various preferred embodiments it will be apparent to those skilled in the art that the present invention provides a significant advance in the technology of dental impression trays. Particularly significant in this regard is the potential the invention affords for providing a dental impression tray which is easier for both a patient and a doctor to use. Additional features and advantages of various preferred embodiments will be better understood in view of the detailed description provided below.

### BRIEF DESCRIPTION OF THE DRAWINGS

FIG. 1 is a side view of a metal dental impression tray in accordance with a preferred embodiment showing the frame and the mesh.

FIG. 2 is a side view taken along line 2-2 in FIG. 1, showing the structural arcs, the transition area and the gap of the distal end of a frame of the tray.

FIG. 3 is a cross section taken through line 3-3 in FIG. 1, showing the distal bar end tapered to prevent impingement of soft tissue.

FIG. 4 is a cross section view taken along line 44 in FIG. 1, showing the top and bottom retention bars.

FIG. 5 is a side view showing the mesh secured to the left side wall at the left side wall gap.

It should be understood that the appended drawings are not necessarily to scale, presenting a somewhat simplified representation of various preferred features illustrative of the basic principles of the invention. The specific design features of the dental impression tray disclosed here, including, for example, the specific dimensions of the frame and tray will be determined in part by the particular intended application and use environment. Certain features of the illustrated embodiments have been enlarged or distorted relative to others to enhance visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the dental impression tray disclosed here. The following detailed discussion of various alternative and preferred features and embodiments will illustrate the general principles of the invention with reference to a dental impression tray particularly suitable for use as a dual arch tray, where dental impression can be taken of a section of upper teeth and a corresponding section of lower teeth simultaneously. Other embodiments suitable for other applications will be apparent to those skilled in the art given the benefit of this disclosure.

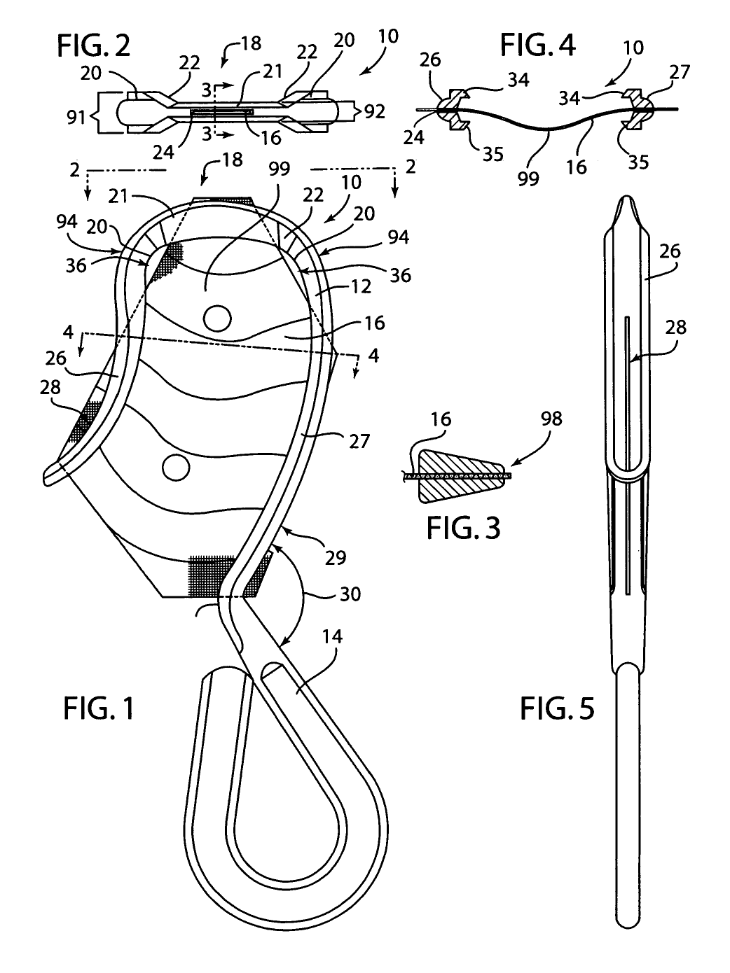

Referring now to the drawings, FIG. 1 shows a dental impression tray 10 where a frame 12 is made of metal, preferably aluminum or stainless steel. The frame 12 is preferably formed to have several key sections: a handle 14, a left (lingual) side wall 26, a right (buckle) side wall 27, and a distal bar 18. The distal bar comprises a distal end 21 and structural arcs 20 on either side of the distal end which connect directly to the left and right side walls. The handle 14 is connected to the rest of the frame, preferably at an angle 30 of about 120 degrees so that the left or lingual side of the handle (as seen in FIG. 1) is generally aligned with a vertical facial/dental midline. This alignment advantageously allows a dentist to insert the tray into the mouth of a patient and have the tray properly aligned with the patient's teeth and gums, even when the patient's mouth is closed.

A mesh 16 is pinched to the frame 12 at three gaps: left side gap 28, right side gap 29, and distal end gap 24 so as to cover most of a central area 99. Silicone or other suitable dental impression materials may be applied to both sides of the mesh 16 so that dental impressions can be made on both a top row and a bottom row of teeth. Openings 36 are located between the mesh 16 and the structural arcs 20 near the corresponding generally right angle bends 94 in the metal frame 12.

In accordance with a highly advantageous feature, the frame 12 is formed from a unitary piece of solid aluminum wire, for example 3/16 of an inch in thickness. The wire is cut to length, for example, 8 inches, and in additional to bending the wire into the shape of the frame, the gaps 28, 29, 24 are cut into the wire. FIG. 5 shows the left side wall gap 28. The right side wall gap 29 is analogously formed. Once the wire has been cut and bent and the gaps formed, the mesh 16 may be inserted into a central area 99 between the left and right side walls, 26, 27 and into the frame gaps 28, 29, 24, and the frame is stamped at these gaps, stamping the gaps and securing the mesh to the frame.

FIG. 2 shows the distal end gap 24 and structural arcs 20. Preferably the distal bar 16 of the frame 12 has transition areas 22 which are tapered from the structural arcs 20 to the distal end 21. The distal end gap 24 which receive the mesh 16 ends near the beginning of the transition areas 22. Preferably neither the transition areas nor the structural arcs 20 have the gap 24.

As best seen in FIG. 1, structural arcs 20 extend at least partially around a bend 94 in the frame 12 defined as the area of the frame between the portion of the frame 12 aligned generally parallel with a row of teeth (when in an operative position in the mouth), i.e., the left and right side walls, 26, 27, and the portion of the frame 12 aligned generally perpendicular to the row of teeth (when in the operative position), i.e., the distal end 21. The frame is subject to competing design constraints. On the one hand, it is desirable to provide side walls having a relatively large height or thickness to help maintain rigidity and thereby produce a more accurate dental impression. On the other hand, the retro molar pad area of a patient's mouth limits the height of the distal end 21. In accordance with a highly advantageous feature, it has been found that extending the portion of the frame with a large height 91 to include the structural arc 20, so that the large height portion of the frame extends at least partially around the bend, advantageously provides sufficient strength to produce good dental impressions while allowing for the reduced height 92 at the distal end to allow for clearance in the retro molar pad area. More specifically, the left and right side walls 26, 27 each have a height 91, and the structural arcs 20 have the same height 91. The distal end has a second height 92 less than the height of the side walls and structural arcs. (FIG. 2). Extending this thicker segment of frame at least partially around the bend, prior to the necessary tapering at the distal end (to avoid the retro molar pad) advantageously increases the rigidity of the side walls, especially the left side wall 26. Increasing rigidity is important for creation of an accurate dental impression. Left side wall 26 is shown in the drawings as the side wall that does not have the handle 14 attached.

Owing to the strength of the muscles in the jaw and the irregular shape of the teeth and surrounding tissue, it has been found that slight changes in design of dental impression trays can have important effects both in terms of accuracy of the dental impression prosthesis and as well as comfort to the patient. In accordance with another highly advantageous feature, the mesh is attached at the distal end 21 as well as the left and right side walls. This advantageously helps secure the mesh to the frame, while maintaining structural arcs that do not contain gaps helps maintain overall tray rigidity, increasing the accuracy of the dental impression generated using these trays. As it is not desirable to keep the mesh too taut, preferably the force used to stamp the gaps is such that there is still some give in the mesh. This allows the mesh to adapt more accurately to the shape of the teeth and bite during the closing of the patient's mouth without placing horizontal forces on either side wall of the tray.

As seen in FIG. 3, in accordance with a highly advantageous feature, the distal end 21 of the distal bar 98 extends remotely from the central area 99 of the mesh. Optionally this tapering of the frame 12 may be done at the same time that the gaps are stamped. Since space between the upper jaw and the lower jaw at the retro molar pad area of a patient is limited, tapering the distal bar in this manner is advantageous in that it helps prevent impingement of soft tissue.

FIG. 4 shows a cross section view taken along line 44 in FIG. 1, showing top and bottom retention bars 34, 35 positioned on both the left and right side walls, 26, 27 and extending toward the central area 99. The purpose of the retention bars is to create a mechanical undercut to help captivate the dental impression material added to either side of the mesh. Preferably the retention bars are formed as unitary projections of the frame 12.

The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A metal dental impression tray comprising, in combination:
a frame comprising a left side wall, a right side wall, and a distal bar, wherein the distal bar comprises a distal end and structural arcs on either side of the distal end connect the distal bar to the corresponding left and right side walls; and
a mesh attached to the frame at the left side wall, the right side wall, and at the distal end, and the mesh cooperates with the frame to define openings formed between the mesh and the structural arcs.

2. The metal dental impression tray of claim 1 wherein the frame further comprises a unitary piece of aluminum.

3. The metal dental impression tray of claim 1 further comprising gaps formed in the left side wall, right side wall and distal bar, respectively, wherein the mesh is positioned in the gaps.

4. The metal dental impression tray of claim 3 wherein the frame is stamped at the gaps, securing the mesh to the frame.

5. The metal dental impression tray of claim 1 wherein the frame is made from one of aluminum and aluminum alloy wire.

6. A metal dental impression tray comprising, in combination:
a frame comprising a left side wall, a right side wall, and a distal bar, which cooperate to define a central area, wherein the distal bar comprises a distal end and structural arcs on either side of the distal end which connect to a corresponding left and right side wall; and
a mesh attached to the frame;
wherein the distal bar is tapered so as to be wider near the central area and narrower away from the central area.

7. The metal dental impression tray of claim 6 wherein the left side wall and right side wall have a corresponding top retention bar and a bottom retention bar extending toward the central area, and the mesh is positioned between the top retention bars and the lower retention bars.

8. The metal dental impression tray of claim 6 wherein the frame further comprises a handle remote from the distal bar.

9. The metal dental impression tray of claim 8 wherein the handle is connected to right side wall at an indentation.

10. The metal dental impression tray of claim 6 wherein a distal end gap is positioned in the distal end of the distal bar, the mesh extends into the gap and the distal end is stamped, securing the mesh to the frame at the distal end.

11. The metal dental impression tray of claim 10 wherein the distal bar further comprises transition areas connecting the distal end to the structural arcs.

12. A metal dental impression tray comprising, in combination:
a frame comprising a left side wall, a right side wall, and a distal bar, which cooperate to define a central area, wherein the distal bar comprises a distal end and structural arcs on either side of the distal end which connect to a corresponding left and right side wall; and
a mesh attached to the frame;
wherein the left side wall and right side wall have a corresponding top retention bar and a bottom retention bar extending toward the central area, and the mesh is positioned between the top retention bars and the lower retention bars.

13. A metal dental impression tray comprising, in combination:
a frame comprising a left side wall, a right side wall, and a distal end, and a pair of structural arcs, each structural arc extending at least partially around a generally right angle bend in the frame and connecting the distal end to the corresponding left and right side walls, respectively; and
the left side wall and right side wall each have a height, the structural arcs have the same height as the side walls, and the distal end has a second height less than the height of the side walls and structural arcs.

14. The metal dental impression tray of claim 13 further comprising a lingual side wall and a buckle side wall of the frame, and a handle connected to buckle side of the frame at an angle.

15. The metal dental impression tray of claim 14 wherein the angle is about 120 degrees.
